(19) United States
(12) Patent Application Publication
(10) Pub. No.: US 2023/0278186 A1
(43) Pub. Date: Sep. 7, 2023

(54) Self-Aligning Bearing Support Assembly

(71) Applicant: Robert Bosch GmbH, Stuttgart (DE)

(72) Inventors: Fernando Porchas Iniguez, Buffalo Grove, IL (US); Luis Felipe Gonzalez Jauregui, Mexicali (MX); Jaime Moreno Terrazas, Imperial, CA (US)

(21) Appl. No.: 17/683,755

(22) Filed: Mar. 1, 2022

(51) Int. Cl. B25F 5/00; F16C 23/08

(52) U.S. Cl. CPC B25F 5/006; F16C 23/08; F16C 2380/26

(57) ABSTRACT

A bearing support assembly for supporting a bearing of an electric motor output shaft relative to a housing. The bearing assembly includes a rigid cap that receives the bearing and resilient boot disposed in the cap between the bearing and cap inner surface. The cap has an irregularly shaped outer surface that interfaces with housing structures to permit the small motions over five degrees of freedom. The bearing support assembly permits self-alignment of the bearing with respect to the motor output shaft and also permits adjustment of natural frequencies of the system that includes the motor, the bearing and the housing. As a result, an improved response to mass unbalances and external loads is achieved.

### BACKGROUND

Many conventional power tools include an electric motor that is disposed in a housing along with other components which are selected based on the working principle of each individual tool. The electric motor includes a stator and a rotor that is disposed in the stator and is driven to rotate by the stator. The rotor is fixed to an output shaft of the electric motor and is radially spaced relative to the stator by an air gap. In general, electric motors having a small air gap may be more efficient than the same motor having a larger air gap. In some applications, the air gap may be very small, for example approximately 0.5 mm or less.

The rotational motion output by the electric motor is transmitted to a tool accessory such as a bit or abrasive pad via an output shaft of the electric motor. During power tool operation the tool accessory is applied to a work piece to perform work, resulting in loading of the motor output shaft. Bearings may be used to support the motor output shaft relative to a housing of the power tool, and an important function of the bearings is to support the motor output shaft in such a way that the air gap is maintained regardless of the magnitude or direction of loads applied to the motor output shaft and a collision between the rotor and stator is avoided.

In addition to loads applied to the output shaft, vibration and noise are also generated during power tool operation. The extent of vibration and noise generated by the power tool depends on several factors including mass unbalance. Among those factors, the degrees of freedom and the stiffness and damping of the system (e.g., the motor including the output shaft, the power tool housing, the bearings and the bearing supports) are major contributors; these are mainly derived from the mass, the mechanical properties of materials and the connections between elements of the system.

It is desirable to reduce the vibration and noise generated by the power tool in order to improve user experience and reduce user fatigue, while maintaining a predetermined air gap between the stator and the rotor of the electric motor.

### SUMMARY

A power tool including an electric motor having a self-aligning rotor support assembly permits adjustment of natural frequencies of the system an improves the power tool's response to mass unbalances and external loads. The rotor support utilizes a dual interface spherical-cylindrical joint with an optional intermediate damping material. The rotor support assembly permits self-alignment of the rotor, thus providing a robust assembly and improved operation of the electric motor.

The specific configuration of the rotor support assembly is based on the characteristics of the power tool (e.g., type of motion and frequency of motion) and its topology. An important feature of rotor support is design flexibility that permits adjustment of the final power tool vibration and noise profiles to an acceptable level. This is done by parametrizing different aspects of the rotor support assembly that directly affect the transmissibility and dissipation of the vibration and noise throughout the power tool, as well as mitigation of the loads to which it is subjected during its operation. Such aspects include, but are not limited to, the shape, workpiece material, interface contact and degrees of freedom.

The rotor support assembly includes a cap having surface features that engage with corresponding structures of the tool housing such that the cap is supported by the tool housing. In particular, the cap is supported by the tool housing in such a way that the cap is moveable relative to the tool housing within predetermined distances along two orthogonal axes and is rotatable relative to the tool housing within predetermined angles about the three orthogonal axes. By this configuration, the rotor support assembly restricts the movement of the motor inside the power tool while providing the desired degrees of freedom to couple this component with the desired output mechanism to which the mechanical energy is transmitted. Restriction of movement of the motor inside the power tool facilitates maintenance of the small (e.g., about 0.4 mm to 0.5 mm) air gap between the motor rotor and the motor stator. Further advantageously, the rotor support assembly adjusts natural frequencies of the system and improve its response to mass unbalances and external loads. The rotor support assembly allows the rotor to self-align when perturbed by internal and/or external loads on the system. In addition, the rotor support assembly prevents over-constraining during assembly process.

In addition, the rotor support assembly may optionally include a resilient boot disposed between the bearing and the cap. The boot dampens transmission of motor vibrations to the tool housing, thus reducing vibration transmission to the user's hand and improving user experience. In addition, the boot provides compliance within the support assembly that accommodates motor misalignment and bearing motion due to part tolerances.

Thus, the rotor support assembly provides a dual interface spherical-cylindrical joint, where a first interface of the dual-interface exists between the cap and the tool housing, and a second interface of the dual interface exists between the boot and the cap.

In some aspects, a power tool includes a tool housing and an electric motor disposed in the tool housing, the electric motor including a motor output shaft. The power tool includes a bearing that rotatably supports an end of the motor output shaft. In addition, the power tool includes a support assembly disposed in the tool housing. The support assembly supports the bearing relative to the tool housing. The support assembly includes a cap having a cap sidewall that surrounds a centerline of the cap. An inner surface of the cap sidewall defines a cap recess that receives the bearing. The cap is supported by the tool housing in such a way that the cap is moveable relative to the tool housing within predetermined distances along two orthogonal axes and is rotatable relative to the tool housing within predetermined angles about the three orthogonal axes.

In some embodiments, the bearing is disposed within the recess such that an outer race of the bearing is fixed relative to the cap.

In some embodiments, an outer surface of the cap sidewall includes a cap first portion that is convex, the cap first portion extending along a circumference of the cap sidewall between a cap first shoulder and a cap second shoulder. In addition, the outer surface of the cap sidewall includes a cap second portion that is convex and is positioned opposite to the cap first portion.

The cap second portion extends along a circumference of the cap sidewall between a cap third shoulder and a cap fourth shoulder. An inner surface of the tool housing includes a housing first portion that is concave. The housing first portion extends between a housing first shoulder and a housing second shoulder. In addition, an inner surface of the tool housing includes a housing second portion that is convex and opens facing the housing first portion. The housing second portion extends between a housing third shoulder and a housing fourth shoulder. The housing first portion and the housing second portion cooperate to support the cap with respect to the tool housing.

In some embodiments, the cap first portion is received within the housing first portion such that the cap first shoulder faces the housing first shoulder and the cap second shoulder faces the housing second shoulder. In addition, the cap second portion is received within the housing second portion such that the cap third shoulder faces the housing third shoulder and the cap fourth shoulder faces the housing fourth shoulder.

In some embodiments, the outer surface of the cap sidewall includes a cap third portion that is planar and is disposed along a circumference of the cap sidewall between the cap first shoulder and the cap third shoulder, and a cap fourth portion that is planar and is disposed along a circumference of the cap sidewall between the cap second shoulder and the cap fourth shoulder.

In some embodiments, the cap includes flats arranged in opposed pairs about a circumference of the cap sidewall inner surface.

In some embodiments, the cap includes an endwall that closes one end of the cap sidewall, and the endwall includes a central opening.

In some embodiments, the support assembly includes a resilient boot that is disposed between the cap sidewall inner surface and the bearing.

In some embodiments, the boot includes a hollow, cylindrical boot sidewall, a first rim that protrudes inward from an inner surface of the boot sidewall and is disposed at a first end of the boot sidewall, and a second rim that protrudes inward from the inner surface of the boot sidewall and is disposed at a second end of the boot sidewall. The inner surface of the boot sidewall, the first rim and the second rim defining an inner groove that is configured to receive a portion of the bearing.

In some embodiments, the boot includes a hollow, cylindrical boot sidewall, an inner surface of the boot sidewall including a circumferential groove that is shaped and dimensioned to receive and retain an outer race of the bearing.

In some aspects, a housing assembly includes a housing, a shaft at least partially disposed in the housing, and a bearing disposed in the housing. The bearing supports the shaft for rotation relative to the housing. In addition, the housing assembly includes a bearing support assembly configured to support the bearing with respect to the housing. The bearing support assembly includes a cap having a cap sidewall that surrounds a centerline of the cap. An inner surface of the cap sidewall defines a cap recess that receives the bearing. The cap is supported by the housing in such a way that the cap is moveable relative to the housing within predetermined distances along two of three orthogonal axes and is rotatable relative to the housing within predetermined angles about the three orthogonal axes.

In some embodiments, the bearing support assembly comprises a boot disposed in the cap, the boot being fixed relative to the cap and enclosing a portion of the bearing, the boot being more resilient than the cap.

In some embodiments, an outer surface of the cap sidewall includes a cap first portion that is convex, the cap first portion extending along a circumference of the cap sidewall between a cap first shoulder and a cap second shoulder. In addition, the outer surface of the cap sidewall includes a cap second portion that is convex and is positioned opposite to the cap first portion.

The cap second portion extends along a circumference of the cap sidewall between a cap third shoulder and a cap fourth shoulder. An inner surface of the tool housing includes a housing first portion that is concave, the housing first portion extending between a housing first shoulder and a housing second shoulder. In addition, the inner surface of the tool housing includes a housing second portion that is convex and opens facing the housing first portion. The housing second portion extends between a housing third shoulder and a housing fourth shoulder. The housing first portion and the housing second portion cooperate to support the cap relative to the tool housing.

### BRIEF DESCRIPTION OF THE FIGURES

FIG. 1 is a perspective view of a hand-held rotary power tool.

FIG. 2 is a cross-sectional view of the power tool as seen along line 2-2 of FIG. 1.

FIG. 3 is an enlargement of the portion of FIG. 2 indicated in broken lines illustrating the support assembly in side section as viewed facing the tool right side housing.

FIG. 4 is a cross sectional view of a portion of the power tool illustrating the support assembly in side section as viewed facing the tool housing left side half shell.

FIG. 5 is a cross sectional view of a portion of the power tool illustrating the support assembly in plan section as viewed facing the tool bottom.

FIG. 6 is a cross-sectional view of the power tool as seen along line 6-6 of FIG. 1.

FIG. 7 is a cross-sectional view of the power tool as seen along line 7-7 of FIG. 1.

FIG. 8 is a front side perspective view of a portion of the tool housing left side half shell illustrating the support assembly, rear support bearing and motor output shaft with the tool housing right side half shell and other ancillary structures omitted.

FIG. 9 is a rear side perspective view of a portion of the tool housing left side half shell illustrating the support assembly, rear support bearing and motor output shaft with the tool housing right side half shell and other ancillary structures omitted.

FIG. 10 is a front side perspective view of the support assembly, rear support bearing and motor output shaft in isolation.

FIG. 11 is a cross-sectional view of the support assembly as seen along line 11-11 of FIG. 10.

FIG. 12 is a front perspective view of the cap of the support assembly.

FIG. 13 is a rear perspective view of the cap of the support assembly.

FIG. 14 is a front perspective view of the boot of the support assembly.

FIG. 15 is a cross-sectional view of the boot as seen along line 15-15 of FIG. 14.

FIG. 16 is a front perspective view of an alternative embodiment boot.

FIG. 17 is a cross-sectional view of the alternative embodiment boot as seen along line 17-17 of FIG. 16.

FIG. 18 is a cross-sectional view of an alternative embodiment support assembly including the boot of FIG. 16.

### DETAILED DESCRIPTION

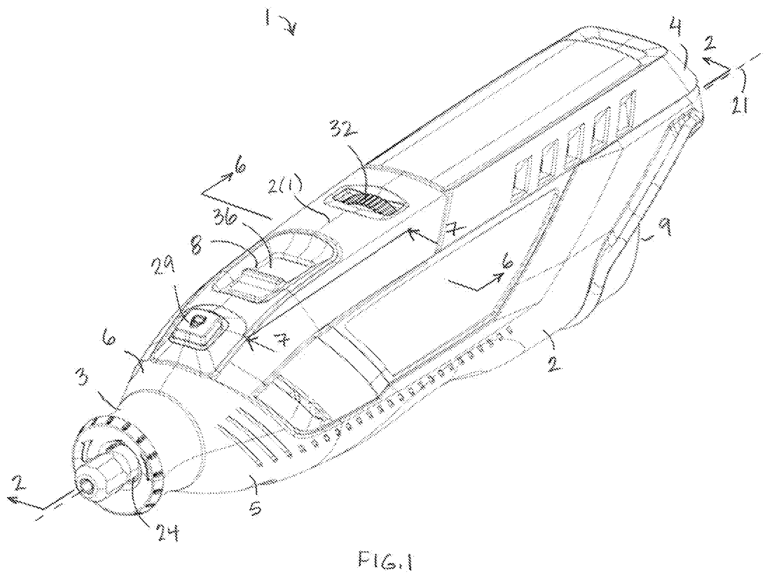

Referring to FIGS. 1-4, a hand-held rotary power tool 1 includes an electric motor 22 disposed in a tool housing 2. The tool housing 2 has a generally cylindrical shape that is ergonomically contoured to be grasped in the hand of a user, whereby the tool housing 2 serves as a handle of the power tool 1. An output shaft 23 of the electric motor 22 extends in parallel to a longitudinal axis 21 of the tool housing 2 and is connected in a gearless fashion to a tool spindle 24. The tool spindle 24 protrudes outward from a first end 3 (e.g., front end) of the tool housing 2 and is configured to provide a mechanical connection to various accessories (not shown) for the purpose of processing a workpiece. The accessories may include, but are not limited to, an engraving cutter, a milling cutter, a sanding band, a grinding disk, a grindstone, a polishing tip, a polishing disk, a polishing brush, a cutter disk, a saw blade and a drill. The motor output shaft 23 is supported within the tool housing 2 by a front bearing 25 disposed between the motor 22 and the tool spindle 24, and a rear bearing 26 disposed on an opposed side (e.g., the rear side) of the motor 22 relative to the front bearing 25. The rear bearing 26 is supported relative to the tool housing 2 by a bearing support assembly 40. The bearing support assembly 40 permits self-adjustment of the position and orientation of the rear bearing 26 relative to the tool housing 2 and motor output shaft 23. As a result, the natural frequencies of the power tool 1 can be adjusted, and response of the power tool 1 to mass unbalances and external loads is improved. In addition, the bearing support assembly 40 permits the motor output shaft 23 to self-align when perturbed by internal and/or external loads. The bearing support assembly 40 will be described in detail below.

The electric motor 22 may be, but is not limited to, a brushless direct current motor that includes a rotor 18 that is disposed in, and rotates with respect to, a stator 20 that is formed of permanent magnets arranged about the circumference of the rotor 18. The rotor 18 includes stacked laminations that are wound with a set of insulation-covered windings. The rotor 18 is in electrical contact with a commutator 19 and rotates in response to the magnetic field generated by the stator 20. The rotor 18 is fixed to the motor output shaft 23 and drives motor output shaft 23 to rotate.

The electric motor 22 is powered by a power supply (not shown) that is disposed in the tool housing 2. The power supply is connected to the electric motor 22 via an electric circuit that is disposed in the tool housing 2. The power tool 1 includes an electrical switch 38 that is disposed in the electrical circuit and controls the on-off state of the electric motor 22. The electrical switch 38 is entirely disposed within the tool housing 2 and is actuated by an operator of the power tool 1 via a switch actuator 36. The switch actuator 36 is disposed in tool housing 2 so as to be accessible to an operator of the power tool 1 via a switch opening 8 provided in the tool housing 2.

In the illustrated embodiment, the power supply is a rechargeable battery pack that is received in a battery opening 9 provided in the second end 4 (e.g., rear end) of the tool housing 2. In other embodiments, the power supply may be remote from the tool housing 2 and connected to the tool housing 2 via a cord (not shown) that encloses an electrically conductive wire.

When the switch actuator 36 is operated so that the electrical switch 38 is closed, the electric motor 22 drives the tool spindle 24 at a rotational speed that may, for example, be in a range of 5000 rotations per minute to 40,000 rotations per minute. In some embodiments, the rotational speed of the electric motor 22 is constant, whereas in other embodiments the rotational speed can be adjusted by the user via a rotary speed control knob 32.

The power tool 1 includes an output shaft lock mechanism 28 having a depressible control button 29 that caps a locking shaft 30. The locking shaft 30, when actuated by the control button 29, is configured to prevent rotation of the output shaft 23 while an accessory is being attached thereto.

The tool housing 2 encloses the motor 22, the electrical switch 38, the switch actuator 36, the output shaft lock mechanism 28, the front and rear bearings 25, 26, a printed circuit board 27 that supports a controller (not shown) and other ancillary components and structures. The controller, for example, may control a voltage supplied to the electric motor 22.

In the illustrated embodiment, the tool housing longitudinal axis 21 extends between the opposed tool housing first and second ends 3, 4, and is generally parallel to the motor output shaft 23. In addition, the tool housing 2 is elongated along the tool housing longitudinal axis 21. The tool housing 2 is a rigid, thin-walled structure that includes two “half shells,” 5, 6 that fit together to enclose the other components of the power tool 1. The half shells 5, 6 form left and right sides of the tool housing 2 that are joined along a seam 2(1) that extends longitudinally along the top and bottom of the power tool 1. As used herein, the terms “top” and “bottom” are used with respect to the orientation illustrated in FIG. 1 and are not intended to be limiting. The terms “longitudinally” and “radially” are used to indicate a direction relative to the tool housing longitudinal axis 21. The term “laterally” is used to indicate a direction toward a side of the tool housing 2, for example toward the half shells 5, 6 at a location that is spaced apart from the seam 2(1).

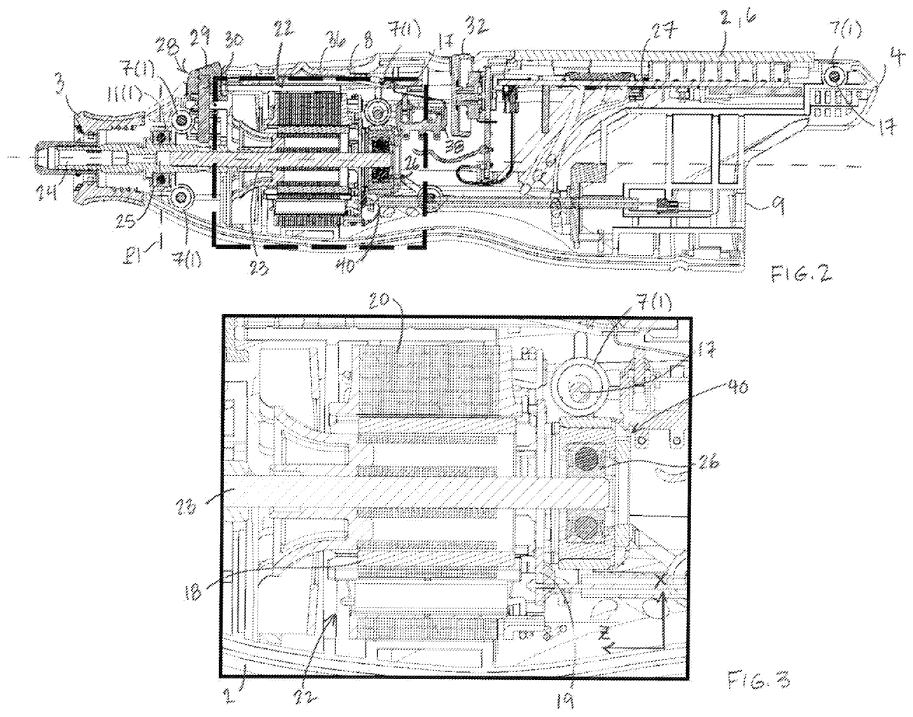

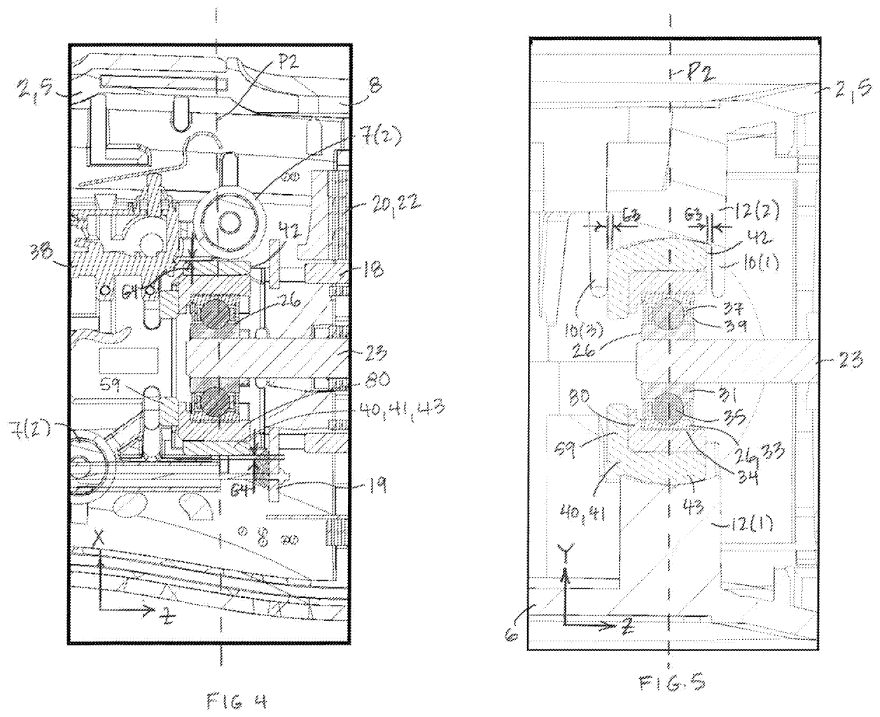

The half shells 5, 6 are retained in the joined configuration via fasteners 17 that are received in, and form a connection between, opposed pairs of bosses 7(1), 7(2). Boss pairs are provided near the tool housing first and second ends 3, 4 and at strategic locations between the tool housing first and second ends 3, 4. For each boss pair, a first boss 7(1) protrudes inward from an inner surface of the right side half shell 6, and a second boss 7(2) protrudes inward from an inner surface of the left side half shell 5. The first and second bosses 7(1), 7(2) may have sufficient length to permit nesting of the respective boss ends. The first and second bosses 7(1), 7(2) are hollow, generally cylindrical protrusions. For each boss pair, a fastener 17 extends between the opposed first and second bosses 7(1), 7(2) and connects them together. In the illustrated embodiment, the tool housing includes five pairs of bosses 7(1), 7(2). In FIGS. 2 and 3, only the right side half shell 6 is shown, while the left side half shell 5 is omitted to permit visualization of the components that are located inside of the tool housing 2 and/or the structure of the interior of the tool housing 2. In FIGS. 4, 8 and 9, only the left side half shell 5 is shown, while the right side half shell 6 is omitted to permit visualization of the components that are located inside of the tool housing 2 and/or the structure of the interior of the tool housing 2.

The front and rear bearings 25, 26 are rolling element bearings. In the illustrated embodiment, the front and rear bearings 25, 26 are ball bearings, and include a plurality of balls 35 that roll between an inner race 31 and an outer race 33. In some embodiments, the relative positions of the balls 35 within the races 31, 33 may be constrained by a cage 37, and a bearing seal 39 may be disposed between the inner race 31 and the outer race 33. In each of the front and rear bearings 25, 26, the motor output shaft 23 extends through the inner race 31 and the inner race 31 is fixed relative to and rotates with the motor output shaft 23.

Referring to FIGS. 2-9, the power tool housing 2 includes several structures that protrude from the tool housing inner surface and that are configured to support the front and rear bearings 25, 26. With respect to the front bearing 25, the outer race 33 is supported by, and fixed relative to, the tool housing 2 via a pair of front bearing holders 11(1). The first front bearing holder 11(1) protrudes inward from an inner surface of the right side half shell 6, and the second front bearing holder (not shown) protrudes inward from an inner surface of the left side half shell 5. The first and second front bearing holders 11(1) reside in a common first plane P1 (FIG. 2) that is transverse to the tool housing longitudinal axis 21. Each of the first and second front bearing holders 11(1) defines a hemi-cylindrical pocket that receives a portion of the front bearing 25.

With respect to the rear bearing 26, the outer race 33 is supported by the bearing support assembly 40 (described below), which in turn is supported relative to the tool housing 2 by a pair of rear bearing holders 12(1), 12(2). The first rear bearing holder 12(1) protrudes inward from an inner surface of the right side half shell 6, and the second rear bearing holder 12(2) protrudes inward from an inner surface of the left side half shell 5. The first and second rear bearing holders 12(1), 12(2) reside in a common second plane P2 (FIGS. 4 and 5) that is transverse to the tool housing longitudinal axis 21. In addition, the first and second rear bearing holders 12(1), 12(2) closely underlie a pair of bosses 7(1), 7(2), which also reside in the second plane P2.

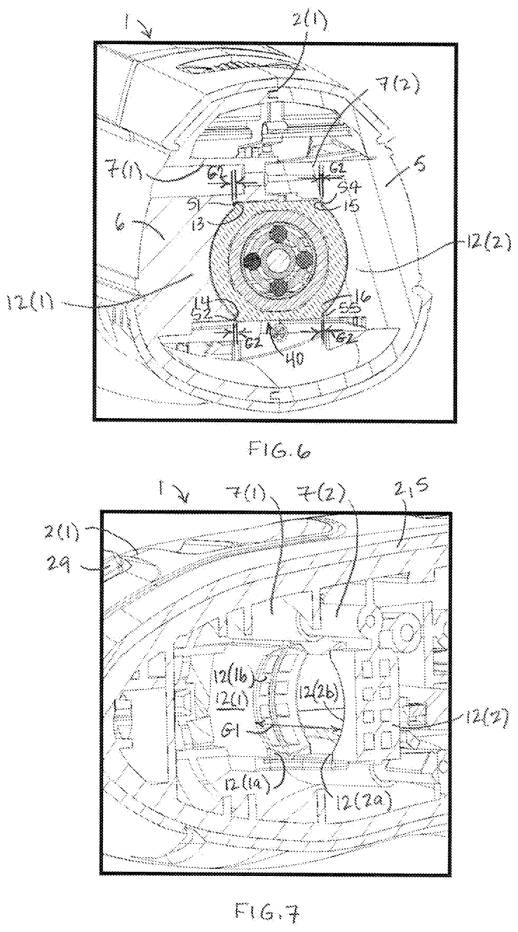

Each of the first and second rear bearing holders 12(1), 12(2) includes an end face 12(1a), 12(2a). The end face 12(1a) of the first housing portion 12(1) faces the end face 12(2a) of the second housing portion 12(2), and a first gap G1 (FIG. 7) exists between the respective end faces 12(1a), 12(2a). Each respective end face 12(1a), 12(2a) includes an arcuate cut out 12(1b), 12(2b). In the illustrated embodiment, the cut outs 12(1b), 12(2b) each define a concave surface having the shape of a portion of a sphere that is centered on the housing longitudinal axis 21. In the illustrated embodiments, each of the cutouts 12(1b), 12(2b) opens facing a lateral side of the tool housing 2.

The first rear bearing holder 12(1) includes a housing first shoulder 13 which corresponds to the intersection of the first cut out 12(1b) with the first end face 12(1a) at a location near the top of the tool housing 2. In addition, the first rear bearing holder 12(1) includes a housing second shoulder 14 which corresponds to the intersection of the first cut out 12(1b) with the first end face 12(1a) at a location near the bottom of the tool housing 2. Similarly, the second rear bearing holder 12(2) includes a housing third shoulder 15 which corresponds to the intersection of the second cut out 12(2b) with the second end face 12(2a) at a location near the top of the tool housing 2. In addition, the second rear bearing holder 12(2) includes a housing fourth shoulder 16 which corresponds to the intersection of the second cut out 12(2b) with the second end face 12(2a) at a location near the bottom of the tool housing 2.

With respect to the rear bearing 26, additional structures protrude from the tool housing inner surface that cooperate with the pair of rear bearing holders 12(1), 12(2) to constrain movement of the bearing support assembly 40 relative to the tool housing 2. In particular, the tool housing 2 includes a first, second and third housing protrusions 10(1), 10(2), 10(3) that protrude inward from an inner surface of the left side half shell 5 (FIGS. 8 and 9). The first, second and third housing protrusions 10(1), 10(2), 10(3) each have the appearance of a narrow plate. The first housing protrusion 10(1) is disposed between the second rear bearing holder 12(2) and the motor 22 so as to be closely spaced with respect to a front-facing surface 42(1) of the cap 41 (FIG. 8). The second and third housing protrusions 10(2), 10(3) are disposed on a side of the second rear bearing holder 12(2) that is opposite to the motor 22 and are closely spaced with respect to a rear-facing surface 59(1) of the cap endwall 59 (FIG. 9). The second housing protrusion 10(2) is located between the housing longitudinal axis 21 and a top of the tool housing 2 so as to be located near the cap first portion 50. The third housing protrusion 10(3) is located between the housing longitudinal axis 21 and a bottom of the tool housing 2 so as to be located near the cap second portion 53. The first, second and third housing protrusions 10(1), 10(2), 10(3) serve to constrain motion of the bearing support assembly 40 to within small, predetermined amounts determined by the longitudinal spacing between the first, second and third housing protrusions 10(1), 10(2), 10(3) and the support assembly. The longitudinal spacing of the first, second and third housing protrusions 10(1), 10(2), 10(3) relative to the support assembly 40 is determined by the requirements of the specific application. In some embodiments, for example the longitudinal spacing may be less than 1 mm.

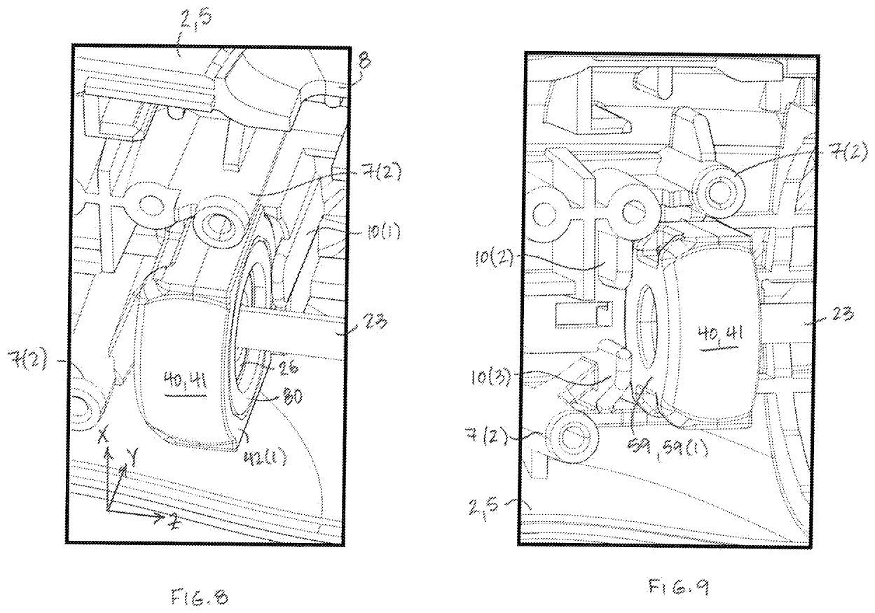

Referring to FIGS. 10 and 11, the bearing support assembly 40 supports, in a self-adjusting manner, the rear bearing 26 within the tool housing 2. The bearing support assembly 40 includes a cap 41 that is disposed in the first gap G1 and supported by the first and second rear bearing holders 12(1), 12(2) of the tool housing 2. The cap 41 receives the rear bearing 26 therein. The bearing support assembly 40 also includes a resilient boot 80 that is disposed in the cap 41. The boot 80 surrounds the rear bearing outer race 33 and resides between the rear bearing 26 and the cap 41. The cap 41 and the boot 80 will now be described in detail.

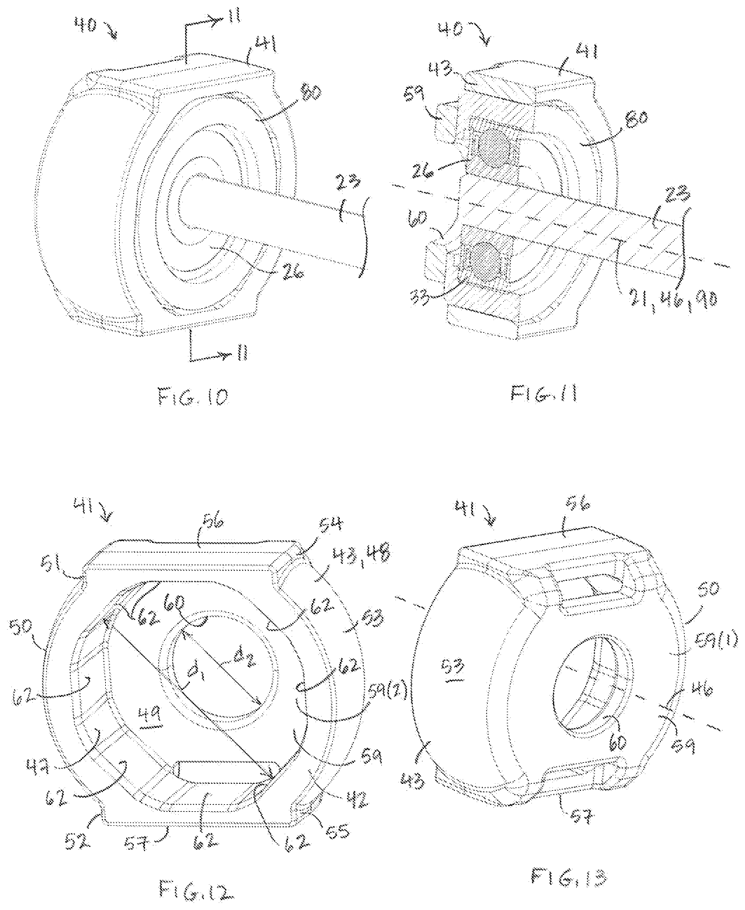

Referring to FIGS. 12 and 13, the cap 41 is a rigid, cup-shaped structure that includes a cap endwall 59 and a cap sidewall 43 that surrounds a periphery of the cap endwall 59. The cap endwall 59 is planar and includes a central opening 60. The cap sidewall 43 protrudes in a direction perpendicular to the cap endwall 59. The end of the cap sidewall 43 that is opposite the cap endwall 59 is referred to herein as the cap open end 42, through which the boot 80 and rear bearing 26 are received in the cap 41. The cap open end 42 has a diameter d1 that is greater than the diameter d2 of the central opening 60.

The cap sidewall 43 surrounds, and is centered on, a cap centerline 46. A cap recess 49 is defined by an inner surface 47 of the cap sidewall 43 and an inner surface 59(2) of the cap endwall 59. The cap recess 49 receives the boot 80 and the rear bearing 26 therein. The cap sidewall inner surface 47 includes several flats 62 arranged in opposed pairs about a circumference of the cap sidewall inner surface. The flats 62 permit easier insertion of the boot 80 and the rear bearing 26 into the cap recess 49 during assembly. Although the cap sidewall inner surface 47 as illustrated includes eight flats 62 arranged as four opposed pairs, the cap sidewall inner surface 47 is not limited to this number of flats 62. When the cap 41 is disposed in the tool housing 2, the cap recess 49 opens facing the electric motor 22 and the tool housing longitudinal axis 21 extends through the endwall central opening 60.

The sidewall outer surface 48 has an irregular profile when viewed in a direction parallel to the cap centerline 46. In particular, the sidewall outer surface 48 includes cap first and second portions 50, 53 that are convex and are configured to complement the shape and dimensions of the housing cut outs 12(1b), 12(2b). Thus, each of the cap first and second housing portions 50, 53 define a concave surface having the shape of a portion of a sphere, and are dimensioned to be received in the housing cut outs 12(1b), 12(2b) in a sliding fit.

The cap first portion 50 extends along a circumference of the cap sidewall 43 between a cap first shoulder 51 and a cap second shoulder 52. The cap second portion 53 is positioned opposite to the cap first portion 50 and extends along a circumference of the cap sidewall 43 between a cap third shoulder 54 and a cap fourth shoulder 55. Each of the cap first portion 50 and cap second portion 53 have an arc length in a range of 95 to 110 degrees. In addition, the first, second, third and fourth shoulders 51, 52, 54, 55 are parallel to each other. The first and second shoulders 51, 52 are coplanar and the third and fourth shoulders 54, 55 are coplanar.

The sidewall outer surface 48 includes a cap third portion 56 that is generally planar and is disposed along a circumference of the cap sidewall 43 between the cap first shoulder 51 and the cap third shoulder 54. In addition, the sidewall outer surface 48 includes a cap fourth portion 57 that is generally planar and is disposed along a circumference of the cap sidewall 43 between the cap second shoulder 52 and the cap fourth shoulder 55. The cap third portion 56 is on an opposed side of the cap centerline 46 relative to the cap fourth portion 57. In addition, the cap third and fourth portions 56, 57 provide generally parallel surfaces, and the cap third and fourth portions 56, 57 intersect with the respective shoulders 51, 52, 54, 55.

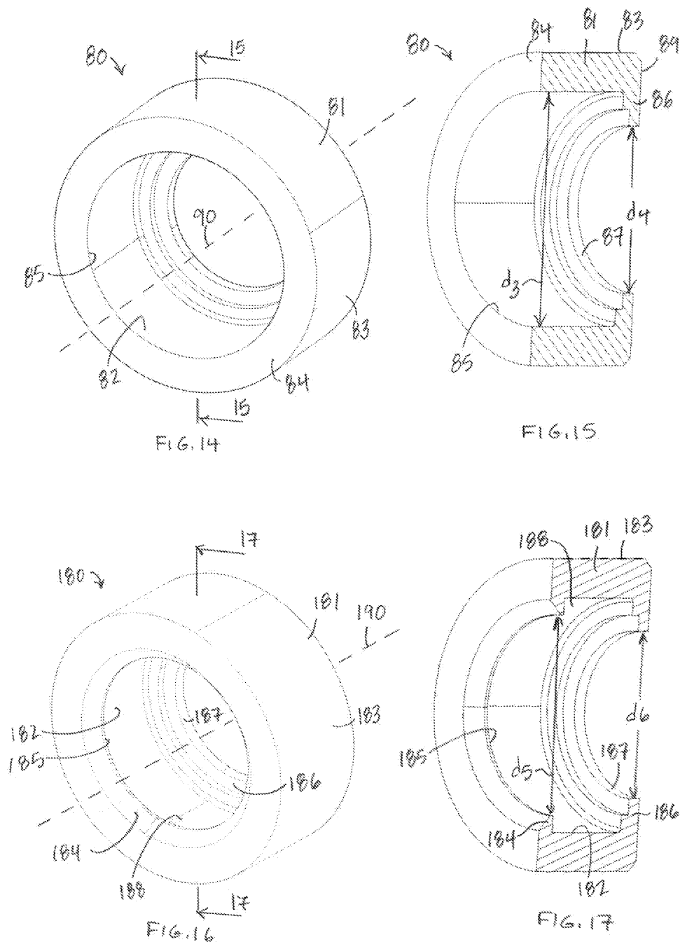

Referring to FIGS. 14 and 15, the boot 80 is shaped and dimensioned to be received in the cap recess 49. The boot 80 is a hollow, generally cylindrical structure that includes a boot sidewall 81. An outer surface 83 of the boot sidewall 81 (e.g., the circumferential outer surface of the boot 80) is cylindrical and generally free of surface features, and is dimensioned to be received, via a press fit, within the cap recess 49. When the boot 80 is assembled with the cap 41, a first end 84 of the boot sidewall 81 is flush with the cap open end 42, and a second end 89 of the boot sidewall 81 abuts the cap endwall 59, and the boot 80 is fixed relative to the cap 41. An inner surface 82 of the boot sidewall 81 is shaped and dimensioned to receive and retain the outer race 33 of the rear bearing 26 in a press fit manner. When the rear bearing 26 is assembled with the boot 80, the bearing outer race 33 is fixed relative to the boot 80.

The boot sidewall 81 includes a rim 86 that protrudes inward from the boot sidewall inner surface 82. The rim 86 is disposed at the boot sidewall second end 89 and thus abuts the cap endwall 59. The boot sidewall first end 84 defines a first boot opening 85. The rim 86 defines a second boot opening 87. The first and second boot openings 85, 87 are centered on a centerline 90 of the boot 80. A diameter d3 of the first opening 85 is greater than a diameter d4 of the second opening 87, and the diameter d4 of the second opening 87 is slightly greater than the diameter d2 of the cap central opening 60.

The boot 80 is formed of a resilient material. For example, the boot 80 may be an elastomer such as silicon rubber. The stiffness of the support assembly 40 can be tuned by selection of an appropriately stiff material for the boot 80.

Referring again to FIGS. 10 and 11, the boot 80 is received in the cap 41 to form the bearing support assembly 40. When the boot 80 is assembled with the cap 41, the boot sidewall outer surface 83 faces the cap sidewall inner surface 47 and the sidewall first end 84 is generally flush with the cap open end 42. In addition, the rim 86 abuts the cap endwall 59, whereby the rim 86 is disposed between the boot sidewall first end and the cap endwall 59. The boot centerline 90 is coaxial with the cap centerline 46, which in turn is coaxial with the tool housing longitudinal axis 21.

Referring again to FIGS. 4-6 and 8-9, the bearing support assembly 40 is assembled with the tool housing 2 so that the cap 41 is disposed between the first and second rear bearing holders 12(1), 12(2) in an orientation in which the cap endwall 59 faces the rear end of the power tool 1, and the cap open end 42 faces the electric motor 22. More particularly, the convex cap first portion 50 is received within the concave first cutout 12(1b) of the first rear bearing holder 12(1) such that the cap first shoulder 51 faces the housing first shoulder 13 and the cap second shoulder 52 faces the housing second shoulder 14. Similarly, the convex cap second portion 53 is received within the concave second cutout 12(2b) of the second rear bearing holder 12(2) such that the cap third shoulder 54 faces the housing third shoulder 15 and the cap fourth shoulder 55 faces the housing fourth shoulder 16.

The pair of rear bearing holders 12(1), 12(2) supports the support assembly 40 within the tool housing 2. In addition, the pair of rear bearing holders 12(1), 12(2) cooperate with the housing protrusions 10(1), 10(2), 10(3) and the adjacent first and second bosses 7(1), 7(2) to constrain motion of the support assembly 40 relative to the tool housing 2. In particular, these housing structures 7(1), 7(2), 10(1), 10(2), 10(3), 12(1), 12(2) are configured to permit the support assembly 40 to move limited predetermined amounts (distances or angles). More specifically, the bearing support assembly 40 supports the rear bearing 26 while permitting five degrees of freedom of the rear bearing 26 relative to the tool housing 2. For example, the rear bearing 26 is permitted to translate a small, predetermined distance along two orthogonal axes X and Z, and is permitted to rotate through a small, predetermined angle about the three orthogonal axes, e.g., axes X, Y, and Z. In this example, the axes X, Y, and Z form an orthogonal reference frame having an origin at the center of the rear bearing in which a positive Z axis is colinear with the longitudinal axis 21 and extends toward the tool housing first end 3, a positive X axis extends through the top of the tool housing 2, and a positive Y axis extends through a right lateral side of the tool housing 2. The extent of translation Tx, Tz and the extent of rotation Rx, Ry, Rz is limited by the interaction between features of the cap sidewall outer surface 48 and one or more housing structures including the features of the first and second rear bearing holders 12(1), 12(2), the housing protrusions 10(1), 10(2), 10(3), and the adjacent pair of bosses 7(1), 7(2).

The details of the interactions between the support assembly 40 and the respective housing structures will now be described.

The housing first, second, third and fourth shoulders 13, 14, 15, 16 of the pair of rear bearing holders 12(1), 12(2) cooperate with corresponding cap first, second, third and fourth shoulders 51, 52, 54, 55 of the bearing support assembly 40 to limit relative motion between the bearing support assembly 40 and the tool housing 2. Small, second gaps G2 exist between the respective shoulders when the output shaft is unloaded (FIG. 6). For example, in some embodiments, the second gaps G2 are configured to allow for a small rotation Rz about the Z axis and/or a small rotation Rx about the X axis. In some embodiments, the small rotation may be less than 5 degrees of rotation. In other embodiments, the small rotation may be in a range of 1.0 degrees to 1.2 degrees of rotation.

The front and rear faces 42(1), 59(1) of the cap 41 cooperate with the respective first, second and third housing protrusions 10(1), 10(2), 10(3) of the tool housing 2 to limit relative motion between the bearing support assembly 40 and the tool housing 2. Small, third gaps G3 exist between the front and rear faces 42(1), 59(1) and the respective first, second and third housing protrusions 10(1), 10(2), 10(3) (FIG. 5). For example, in some embodiments, the third gaps G3 are configured to allow for a small rotation Ry about the Y axis. In some embodiments, the small rotation may be less than 5 degrees of rotation. In other embodiments, the small rotation may be in a range of 1.0 degrees to 1.2 degrees of rotation.

In addition, in some embodiments, the third gaps G3 are configured to allow for a small translation Tz in a direction parallel to the Z axis (e.g., the longitudinal axis 21). In some embodiments, the small translation may be about 0.1 mm to 0.2 mm.

The planar cap third portion 56 cooperates with the overlying first and second bosses 7(1), 7(2) of the tool housing 2 to limit relative motion between the bearing support assembly 40 and the tool housing 2 in the positive X direction, and the planar cap fourth portion 58 cooperates with underlying structures including portions of an electrical harness 61 to limit relative motion between the bearing support assembly 40 and the tool housing 2 in the negative X direction. Small, fourth gaps G4 exist between the cap third and fourth portions 56, 58 and the respective structures 7(1), 7(2), 61 (FIG. 4). The fourth gaps G4 are configured to allow for a small translation Tx in a direction parallel to the X axis. In some embodiments, the small translation may be about 0.1 mm to 0.2 mm.

Thus, the bearing support assembly 40 supports the rear bearing 26 while permitting predetermined degrees of freedom. For example, the cap 41 is supported by the tool housing in such a way that the cap 41 is moveable relative to the tool housing 2 within predetermined distances along two orthogonal axes X, Z and is rotatable relative to the tool housing within predetermined angles about the three orthogonal axes X, Y, Z. The predetermined distances (e.g., gaps G2, G3, G4) are determined based on the requirements of the specific application, and the tool housing 2 is designed to provide the predetermined distances. In particular, the specific configuration of the tool housing structures 7(1), 7(2), 10(1), 10(2), 10(3), 12(1), 12(2) is based on the specific operation of the power tool (e.g., type of motion, frequency of motion) and its topology, and the support assembly 40 permits adjustment of the final vibration and noise profiles to a desired level.

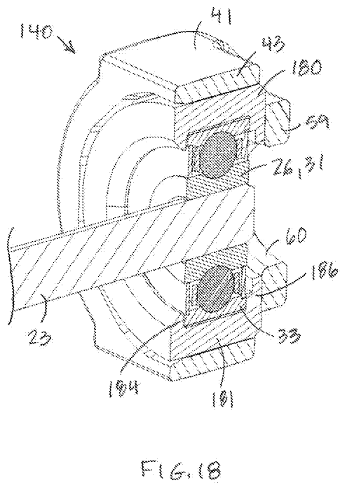

Referring to FIGS. 16-18, in some embodiments, the power tool 1 includes an alternative support assembly 140. The alternative support assembly 140 includes the cap 41 and an alternative boot 180. The alternative boot 180 is similar to the boot 80 described above with respect to FIGS. 10-15 but has a slightly different shape than the earlier-described boot 80. Like the boot 80, the alternative boot 180 is shaped and dimensioned to be received in the cap recess 49. The boot 180 is a hollow, generally cylindrical structure that includes a boot sidewall 181.

An inner surface 182 of the boot sidewall 181 includes a circumferential groove 188 that is shaped and dimensioned to receive and retain the outer race 33 of the rear bearing 26. The groove 188 is defined between first and second rims 184, 186 that protrude inward from the boot sidewall inner surface 182. The first rim 184 is disposed at a first end of the boot sidewall 181, and the second rim 186 is disposed at a second, opposite end of the boot sidewall 181. The first rim 184 defines a first boot opening 185. The second rim 186 defines a second boot opening 187. The first and second boot openings 185, 187 are centered on a centerline 190 of the boot 180. A diameter d5 of the first opening 185 is greater than a diameter d6 of the second opening 187, and the diameter d6 of the second opening 187 is slightly greater than the diameter d2 of the central opening 60. The groove 188 is shaped and dimensioned to receive and retain the bearing outer race 33 in a press-fit manner. The circumferential outer surface 183 of the boot 180 is cylindrical and generally free of surface features.

Although the power tool 1 described herein is a hand-held rotary power tool, the power tool 1 is not limited to tools of this type. In particular, the self-aligning bearing support 40 can be implemented in other types of power tools and in other motor applications to reduce device vibration and noise.

Although the bearing support assembly 40 as described above includes the boot 80 disposed between the cap 41 and the tool housing 2, the bearing assembly 40 is not limited to this configuration. For example, in some embodiments, the boot 80 may be omitted.

Selective illustrative embodiments of the power tool including the bearing support assembly are described above in some detail. It should be understood that only structures considered necessary for clarifying the power tool including the bearing support assembly have been described herein. Other conventional structures, and those of ancillary and auxiliary components of the power tool, the power tool housing and the bearing support assembly, are assumed to be known and understood by those skilled in the art. Moreover, while a working example of the power tool including the bearing support assembly has been described above, the power tool and the bearing support assembly are not limited to the working example described above, but various design alterations may be carried out without departing from the power tool and housing assembly as set forth in the claims.

We claim:

1. A power tool comprising:
a tool housing;
an electric motor disposed in the tool housing and including a motor output shaft;
a bearing that rotatably supports an end of the motor output shaft, and
a support assembly disposed in the tool housing, the support assembly supporting the bearing relative to the tool housing, the support assembly including a cap having a cap sidewall that surrounds a centerline of the cap, an inner surface of the cap sidewall defining a cap recess that receives the bearing,
wherein
the cap is supported by the tool housing in such a way that the cap is moveable relative to the tool housing within predetermined distances along three orthogonal axes and is rotatable relative to the tool housing within predetermined angles about the three orthogonal axes.

2. The power tool of claim 1, wherein the bearing is disposed within the recess such that an outer race of the bearing is fixed relative to the cap.

3. The power tool of claim 1, wherein
an outer surface of the cap sidewall includes
a cap first portion that is convex, the cap first portion extending along a circumference of the cap sidewall between a cap first shoulder and a cap second shoulder, and
a cap second portion that is convex and is positioned opposite to the cap first portion, the cap second portion extending along a circumference of the cap sidewall between a cap third shoulder and a cap fourth shoulder, and
an inner surface of the tool housing includes
a housing first portion that is concave, the housing first portion extending between a housing first shoulder and a housing second shoulder, and
a housing second portion that is convex and opens facing the housing first portion, the housing second portion extending between a housing third shoulder and a housing fourth shoulder,
and wherein
the housing first portion and the housing second portion cooperate to support the cap relative to
the tool housing.

4. The power tool of claim 3, wherein
the cap first portion is received within the housing first portion such that the cap first shoulder faces the housing first shoulder and the cap second shoulder faces the housing second shoulder, and
the cap second portion is received within the housing second portion such that the cap third shoulder faces the housing third shoulder and the cap fourth shoulder faces the housing fourth shoulder.

5. The power tool of claim 3, wherein the outer surface of the cap sidewall includes
a cap third portion that is planar and is disposed along a circumference of the cap sidewall between the cap first shoulder and the cap third shoulder, and
a cap fourth portion that is planar and is disposed along a circumference of the cap sidewall between the cap second shoulder and the cap fourth shoulder.

6. The power tool of claim 1, wherein the cap includes flats arranged in opposed pairs about a circumference of the cap sidewall inner surface.

7. The power tool of claim 1, wherein the cap includes an endwall that closes one end of the cap sidewall, and the endwall includes a central opening.

8. The power tool of claim 1, wherein the support assembly includes a resilient boot that is disposed between the cap sidewall inner surface and the bearing.

9. The power tool of claim 8, wherein the boot comprises
a hollow, cylindrical boot sidewall,
a first rim that protrudes inward from an inner surface of the boot sidewall and is disposed at a first end of the boot sidewall, and
a second rim that protrudes inward from the inner surface of the boot sidewall and is disposed at a second end of the boot sidewall,
the inner surface of the boot sidewall, the first rim and the second rim defining an inner groove that is configured to receive a portion of the bearing.

10. The power tool of claim 8, wherein the boot comprises
a hollow, cylindrical boot sidewall, an inner surface of the boot sidewall including a circumferential groove that is shaped and dimensioned to receive and retain an outer race of the bearing.

11. A housing assembly comprising:
a housing;
a shaft at least partially disposed in the housing,
a bearing disposed in the housing, the bearing supporting the shaft for rotation relative to the housing, and
a bearing support assembly configured to support the bearing with respect to the housing, the bearing support assembly comprising:
a cap having a cap sidewall that surrounds a centerline of the cap, an inner surface of the cap sidewall defining a cap recess that receives the bearing,
wherein
the cap is supported by the housing in such a way that the cap is moveable relative to the housing within predetermined distances along two of three orthogonal axes and is rotatable relative to the housing within predetermined angles about the three orthogonal axes.

12. The housing assembly of claim 11, wherein the bearing support assembly comprises a boot disposed in the cap, the boot being fixed relative to the cap and enclosing a portion of the bearing, the boot being more resilient than the cap.

13. The housing assembly of claim 11, wherein an outer surface of the cap sidewall includes
a cap first portion that is convex, the cap first portion extending along a circumference of the cap sidewall between a cap first shoulder and a cap second shoulder, and
a cap second portion that is convex and is positioned opposite to the cap first portion, the cap second portion extending along a circumference of the cap sidewall between a cap third shoulder and a cap fourth shoulder, and
an inner surface of the tool housing includes
a housing first portion that is concave, the housing first portion extending between a housing first shoulder and a housing second shoulder, and
a housing second portion that is convex and opens facing the housing first portion, the housing second portion extending between a housing third shoulder and a housing fourth shoulder,
and wherein
the housing first portion and the housing second portion cooperate to support the cap relative to the tool housing.
